(19) United States
(12) Patent Application Publication
(10) Pub. No.: US 2015/0362684 A1
(43) Pub. Date: Dec. 17, 2015

(54) PUMP BEAM STRIPPER AND MANUFACTURING METHOD OF THE SAME

(71) Applicant: ELECTRONICS AND TELECOMMUNICATIONS RESEARCH INSTITUTE, Daejeon (KR)

(72) Inventor: Hong Seok SEO, Daejeon (KR)

(73) Assignee: ELECTRONICS AND TELECOMMUNICATIONS RESEARCH INSTITUTE, Daejeon (KR)

(21) Appl. No.: 14/724,084

(22) Filed: May 28, 2015

(30) Foreign Application Priority Data
Jun. 12, 2014 (KR) 10-2014-0071543

(51) Int. Cl. G02B 6/42; G02B 6/036

(52) U.S. Cl. CPC G02B 6/429; G02B 6/4296; G02B 6/03622

(57) ABSTRACT

Provided herein is a pump beam stripper including an optical fiber including a core, a primary cladding configured to surround the core, and a secondary cladding configured to surround the primary cladding, the secondary cladding including an opening that exposes a portion of the primary cladding; and an atypical glass substance deposited irregularly on a surface of the primary cladding exposed through the opening.

### CROSS-REFERENCE TO RELATED APPLICATION

The present application claims priority to Korean patent application No. 10-2014-0071543, filed on Jun. 12, 2014, the entire disclosure of which is incorporated herein in its entirety by reference.

### BACKGROUND

1. Field of Invention

Various embodiments of the present disclosure relate to a pump beam stripper wherein a glass substance is deposited on an external cladding of an optical fiber so that a pump beam passing through the cladding of optical fiber may be efficiently stripped off, and a manufacturing method thereof.

2. Description of Related Art

A conventional high power optical fiber laser is made using an optical fiber having a double cladding structure. Such a double cladding structure optical fiber includes a core, a primary cladding and a secondary cladding. For example, in a silica-based core, a rare-earth ion for an amplification or laser is added. The primary cladding is made of a silica-based cladding for pump beams, and the secondary cladding is made of a polymer with a low refractive index.

In a high power fiber laser, the unabsorbed pump beam which is remained after an amplification may have a high power and may be output through an output port along with an amplified laser. Furthermore, when there is an additional device such as a fiber Bragg grating, isolator, or optical device connected to the output port, the residual pump beam with high power will enter the additional device. Thus, the coating of the optical fiber may burn and/or the inside of the additional device may be damaged by the pump beam.

The same problem may also occur damages in devices connected to an input port of the double clad fiber in the case of backward pumping scheme. Furthermore, when using a cladding pumped fiber in multiple chains of amplifiers, the aforementioned problem may occur in each input/output port of the multiple stages. Therefore, in order to obtain a desirable result at the output ports of each stage, it is necessary to strip off the residual pump beam.

In order to resolve this problem, conventional pump beam strippers were configured in a structure where a primary cladding is regularly chipped to remove a cladding mode related with pump beam. That is, using a CO₂ laser, a surface of the silica optical fiber is chipped, allowing the pump beam to escape from the chipped area. However, it costs a lot to fabricate such a pump beam stripper and it also deteriorates the mechanical strength of the optical fiber. Furthermore, stripping of the pump beam has only a limited effect in the conventional pump beam strippers since only one surface of the optical fiber is regularly chipped.

### SUMMARY

Various embodiments of the present disclosure are directed to a pump beam stripper capable of efficiently stripping off a pump beam that is propagated through the primary cladding of a double clad optical fiber, and a manufacturing method thereof.

An embodiment of the present disclosure provides a pump beam stripper including an optical fiber including a core, a primary cladding configured to surround the core, and a secondary cladding configured to surround the primary cladding, the secondary cladding including an opening that exposes a portion of the primary cladding; and an atypical glass substance deposited irregularly on a surface of the primary cladding exposed through the opening.

Another embodiment of the present disclosure provides a method for manufacturing a pump beam stripper, the method including forming an optical fiber that includes a core, a primary cladding configured to surround the core, and a secondary cladding configured to surround the primary cladding, the secondary cladding including an opening that exposes a portion of the primary cladding; and forming an atypical glass substance deposited irregularly on a surface of the primary cladding exposed through the opening.

According to an embodiment of the present disclosure, a phosphoric acid solution (for example, HPO₃) is deposited on a surface of an optical fiber, and then heated. When the phosphoric acid solution is heated, phosphate (P₂O₅) is generated through an oxidizing process, and the phosphate (P₂O₅) is condensed on a silica optical fiber surface to form a phosphate glass having shapes of very small marbles. According to another embodiment of the present disclosure, silica glass of small marbles is formed using a TEOS solution instead of the phosphoric acid solution.

Herein, the phosphate glass marbles have a high refractive index compared to silica. Furthermore, the phosphate glass marbles and silica glass marbles may be formed to have various diameters, the marbles being arranged irregularly on a surface of a primary cladding. Therefore, an irregular reflection section is formed on the surface of the primary cladding, allowing the residual pump beam to easily escape the primary cladding. Accordingly, this may be used as a pump beam stripper.

Furthermore, it is also possible to add major absorbing dopants such as rare-earth elements or alkali metal or transition metal (Cr, Fe, GE and the like) to the phosphate solution or TEOS solution, thereby manufacturing a more efficient pump beam stripper.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a cross-sectional view illustrating a structure of a pump beam stripper according to an embodiment of the present disclosure;

FIGS. 2A to 2C are cross-sectional views for explaining a method for manufacturing a pump beam stripper according to an embodiment of the present disclosure; and

FIGS. 3A and 3B are cross-sectional views illustrating a structure of a pump beam stripper according to another embodiment of the present disclosure.

### DETAILED DESCRIPTION

Hereinafter, embodiments will be described in greater detail with reference to the accompanying drawings. Embodiments are described herein with reference to cross-sectional illustrations that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘first’ and ‘second’ may be used to describe various components, but they should not limit the various components. Those terms are only used for the purpose of differentiating a component from other components. For example, a first component may be referred to as a second component, and a second component may be referred to as a first component and so forth without departing from the spirit and scope of the present disclosure. Furthermore, ‘and/or’ may include any one of or a combination of the components mentioned.

Furthermore, a singular form may include a plural from as long as it is not specifically mentioned in a sentence. Furthermore, “include/comprise” or “including/comprising” used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

It is also noted that in this specification, “connected/coupled” refers to one component not only directly coupling another component but also indirectly coupling another component through an intermediate component. On the other hand, “directly connected/directly coupled” refers to one component directly coupling another component without an intermediate component.

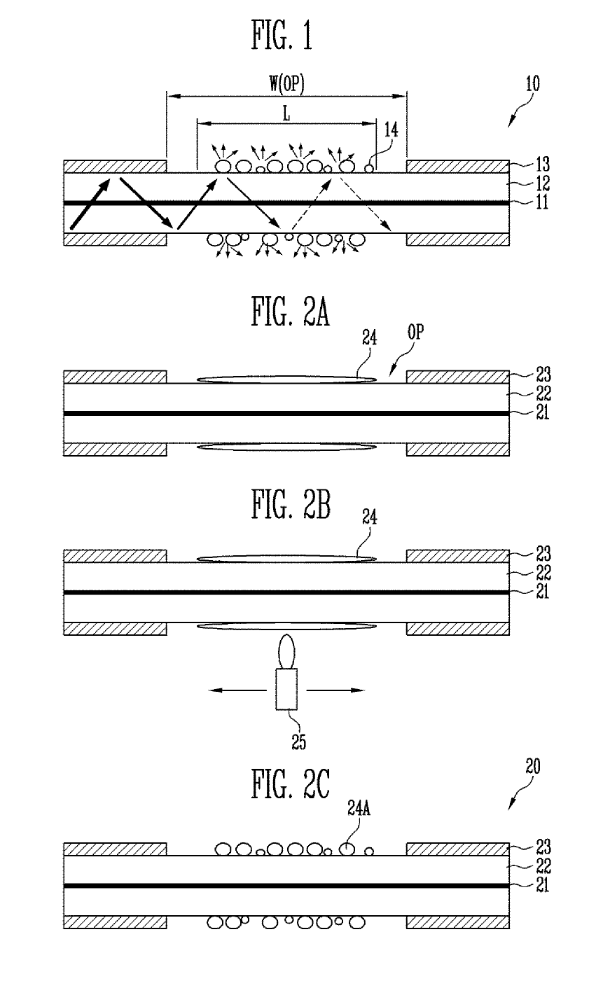

FIG. 1 is a cross-sectional view illustrating a structure of a pump beam stripper according to an embodiment of the present disclosure. The pump beam stripper according to the embodiment of the present disclosure 20 includes an optical fiber, and may be formed by changing some of the structure of the optical fiber.

The optical fiber 10 includes a core 11, primary cladding 12 that surrounds the core 11, and secondary cladding 13 that surrounds the primary cladding 12. That is, the optical fiber may be a double clad optical fiber to be used in high power optical fiber lasers.

The core 11 may be a single mode or multimode core including a rare-earth element. The rare-earth element added to the core 11 is excited by pump beam, and the excited rare-earth ions emit a stimulated beam that proceeds through the core 11. Herein, a cavity is formed inside the core 11, and a laser is oscillated through the cavity. The energy source of the laser formed in the core 11 is the pump beam proceeding to the primary cladding 12, and the oscillated laser has a beam with high power and high quality. Therefore, a single mode or multiple mode optical fiber laser may be formed depending on the conditions of the core 11.

The primary cladding 12 may be a cladding made of silica glass. Furthermore, the secondary cladding 13 may be a cladding made of a low refractive index polymer or a glass doped with fluorine. Herein, a numerical aperture (NA) caused by a difference of refractive index between the primary cladding 12 and secondary cladding 13 is 0.46 or above. Therefore, it is possible to receive beams of various modes emitting from a pumping laser diode.

The primary cladding 12 has a size area that is more than one hundred times larger than that of the core 11, and a difference of refractive index between the primary cladding 12 and the secondary cladding 13 is high enough. Therefore, it is possible to efficiently enter multiple beams from arrayed semiconductor-based lasers having low beam quality and high power into the primary cladding.

The pump beam proceeds through the primary cladding 12, and then absorbed by rare-earth ions in the core 11. Therefore, the pump beam excites the rare-earth ions doped on the core 11 as it crosses the core 11, and the excited ions emit a stimulated light with a high beam quality, and the stimulated beam is largely amplified as it proceeds through the core 11. Therefore, an optical fiber laser of good beam quality is formed through a cavity laser constructed with two mirrors. Furthermore, it is possible to form a high power laser by significantly amplifying a seed laser beam that proceeds to a laser cavity or core 11.

The secondary cladding 13 includes an opening (OP) that exposes the primary cladding 12. That is, by removing a portion or a certain area of the secondary cladding of the double cladding optical fiber, it is possible to form the opening (OP) that exposes the primary cladding 12 to outside. A width (W) of the opening (OP) may be adjusted depending on a strip extent of the cladding mode.

On a surface of the primary cladding 12 exposed through the opening (OP), an atypical glass substance 14 is deposited irregularly. For instance, the glass substance 14 may be a phosphate glass (P₂O₅) marble, silica glass (SiO₂) marble, GeO₂ based glass marble, TiO₂ based glass marble or other composite glass having an irregular size, that is, various diameters. As such, as the atypical glass substance 14 is deposited irregularly, the pump beam proceeding to the primary cladding 12 may be irregularly reflected by the glass substance 14 and leaked outside. That is, residual pump beam is removed.

Herein, the glass substance 14 may be made of various substances besides phosphate glass or silica glass. For example, the glass substance 14 may be made using substances such as TiO₂, GeO₂ and the like that become glass when reacted with oxygen. Especially, since TiO₂, GeO₂, and P₂O₅ have a high refractive index compared to silica, they may form a glass substance 14 that is more efficient in stripping off the pump beam.

Furthermore, the glass substance 14 may have a refractive index that is the same as or greater than the refractive index of the primary cladding 12. A length (L) of deposition of the glass substance 14 may be adjusted depending on a strip extent of the cladding mode.

Meanwhile, the glass substance 14 may include a rare-earth element or alkali metal or transition metal. For example, a chloride type rare-earth elements (ErCl₃, YbCl₃ and the like) or chloride type transition metal (FeCl₃, CrCl₃ and the like) may be added to the solution being deposited on the surface of the primary cladding 12 exposed by the opening (OP). In this case, the glass substance 24A will contain rare-earth ions or transition metal ions in the form of oxides, and will be able to irregularly reflect the pump beam more efficiently. Therefore, a cladding mode stripping will be made more effectively, and the length of the irregular reflection section may be reduced. That is, a shorter pump beam stripper may be manufactured.

FIGS. 2A to 2C are cross-sections for explaining a method for manufacturing a pump beam stripper according to an embodiment of the present disclosure.

Referring to FIG. 2A, there is an optical fiber that includes a core 21, a primary cladding 22 that surrounds the core 21, and a second cladding 23 that surrounds the primary cladding 22, a portion of the secondary cladding 23 is stripped to form the opening (OP) for exposing the primary cladding 22.

Then, a solution 24 is deposited on a surface of the primary cladding 22 exposed through the opening (OP). The solution 24 may be, for example, a phosphoric acid solution or TEOS solution. Furthermore, the solution 24 may include rare earth ions or alkali metal ions or transition metal ions.

Referring to FIG. 2B, the deposited solution 24 is heated. That is, the solution 24 is heated using heat, arc, laser torch, or micro torch. The deposited solution 24 may be heated to a high temperature by moving a torch 25 left and right in the opening (OP).

Referring to FIG. 2C, the solution 24 heated to a high temperature reacts with oxygen and forms a glass substance 24A. For example, a phosphoric acid solution may be reacted with oxygen to form phosphate glass. Herein, the phosphate glass has a coefficient of linear expansion that is different from that of a silica based primary cladding 22, and thus wetting is difficult. Therefore, when heated, phosphate glass marbles having various diameters are formed simultaneously with the oxidation reaction, and the glass marbles are arranged irregularly on the surface of the primary cladding 22. Furthermore, the refractive index of the phosphate glass is 1.54, and the refractive index of silica is 1.457. That is, the phosphate glass has a higher refractive index than the silica based primary cladding 22. Therefore, the pump beam that proceeds to the primary cladding 22 will turns towards the phosphate glass having a high refractive index, and will escape outside through the marble shaped irregularly. In another example, a TEOS solution heated to a high temperature may be reacted with oxygen to form silica (SiO₂) glass. Herein, it is possible to adjust the concentration of the TEOS solution so as to adjust the amount of silica glass to be deposited on the surface of the primary cladding 22. The silica glass formed on the surface of the primary cladding 22 irregularly reflects the residual pump beam proceeding to the primary cladding 22, thereby preventing the residual beam from proceeding towards the primary cladding 22.

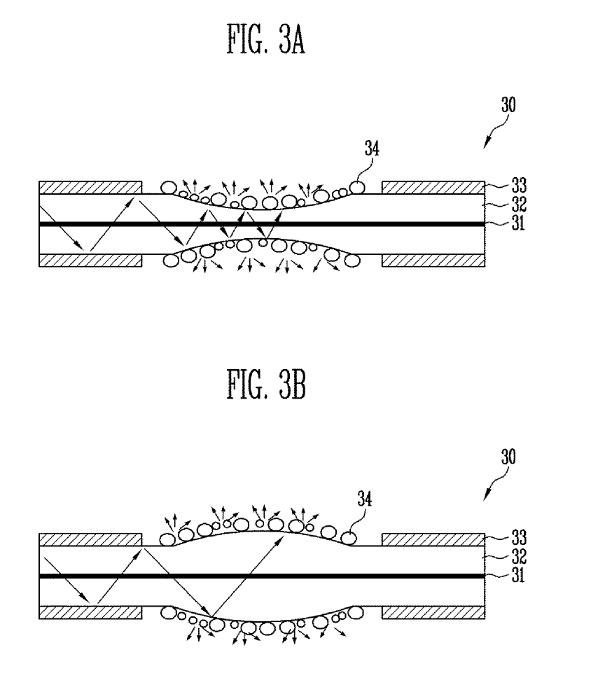

FIGS. 3A and 3B are cross-sectional views illustrating a structure of a pump beam stripper according to another embodiment of the present disclosure.

Referring to FIGS. 3A and 3B, a pump beam stripper 30 includes a core 31, a primary cladding 32 that surrounds the core 31, and a secondary cladding 33 that surrounds the primary cladding 32. Herein, the secondary cladding 33 includes an opening that exposes the primary cladding 32, and on the surface of the primary cladding 22 exposed through the opening, a glass substance 34 like marbles or tiny particles is arranged irregularly forming an irregular reflection section.

Referring to FIG. 3A, the primary cladding 32 has a down taper structure, and in such a down taper structure, the residual pump beams may be effectively removed with a short length although they have a lowest order mode. For example, the down taper structure may be formed by elongating both ends of the optical fiber with a motor stage in addition to heat the primary cladding 32 where the glass substance 34 is formed. Otherwise, it is possible to form the down taper structure during the heating process for forming the glass substance 34, or form the down taper structure in a separate process before forming the glass substance 34.

Referring to FIG. 3B, the primary cladding 32 has an up taper structure. If the intensity of the pump beam remaining in the high power laser is very high, most of the residual pump beam is stripped from a front end of the pump beam stripper 30. Therefore, heat is generated from the front end of the pump beam stripper 31, which may break the optical fiber. When the primary cladding 32 has an up taper structure, however, pump beam may be transited from a higher order mode to a lower order mode. That is, by gradually changing modes of the residual pump beams into lower order modes in the taper region, it is possible to strip gradually the residual pump beam in the up taper section deposited by glass substances. Therefore, it is possible to prevent accumulation of heat due to the pump beam being stripped excessively from a certain area.

The primary cladding 32 may have a structure where both a down taper and up taper are combined.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A pump beam stripper comprising:
an optical fiber including a core, a primary cladding configured to surround the core, and a secondary cladding configured to surround the primary cladding, the secondary cladding including an opening that exposes a portion of the primary cladding; and
an atypical glass substance deposited irregularly on a surface of the primary cladding exposed through the opening.

2. The pump beam stripper according to claim 1,
wherein the glass substance is a phosphate glass (P₂O₅) marble, silica glass (SiO₂) marble, GeO₂-based glass marble, or TiO₂-based glass marble or other composite glass marble.

3. The pump beam stripper according to claim 1,
wherein the glass substance comprises a rare-earth element or alkali metal or transition metal.

4. The pump beam stripper according to claim 1,
wherein a refractive index of the glass substance is the same as or greater than a refractive index of the primary cladding.

5. The pump beam stripper according to claim 1,
wherein the glass substance is a glass marble having various diameters.

6. The pump beam stripper according to claim 1,
wherein the primary cladding has a up taper structure, down taper structure, or a combination of the up taper structure and down taper structure.

7. A method for manufacturing a pump beam stripper, the method comprising:
forming an optical fiber that includes a core, a primary cladding configured to surround the core, and a secondary cladding configured to surround the primary cladding, the secondary cladding including an opening that exposes a portion of the primary cladding; and
forming an atypical glass substance deposited irregularly on a surface of the primary cladding exposed through the opening.

8. The method according to claim 7,
wherein the forming an atypical glass substance comprises:
applying a phosphoric acid solution on a surface of the primary cladding exposed through the opening; and
forming a phosphate glass marble by heating the applied phosphoric acid solution.

9. The method according to claim 8,
wherein the phosphoric acid solution comprises a rare-earth ion or transition metal ion or an alkali metal ion.

10. The method according to claim 7,
wherein the forming a phosphate glass marble comprises:
applying TEOS (TetraEthyl OrthoSilicate) solution on the surface of the primary cladding exposed through the opening; and
forming the silica glass marble by heating the applied TEOS (TetraEthyl OrthoSilicate) solution.

11. The method according to claim 10,
wherein the TEOS (TetraEthyl OrthoSilicate) solution comprises a rare-earth ion or transition metal ion or an alkali metal ion.

12. The method according to claim 7,
further comprising an up taper structure, down taper structure, or a combination of the up taper structure and down taper structure.
